(19) United States
(12) Patent Application Publication
(10) Pub. No.: US 2024/0421410 A1
(43) Pub. Date: Dec. 19, 2024

(54) MODULAR ATTACHMENT OF TABBED BATTERY CELLS

(71) Applicant: Microsoft Technology Licensing, LLC, Redmond, WA (US)

(72) Inventors: Travis Anthony CONRAD, Edmonds, WA (US); Minsoo KIM, Bothell, WA (US); Kianoush NAELI, Bothell, WA (US); Ceceli Ann WILHELMI, Kalaheo, HI (US)

(21) Appl. No.: 18/336,597

(22) Filed: Jun. 16, 2023

(51) Int. Cl. H01M 50/262; H01M 50/211; H01M 50/284; H01M 50/517; H01M 50/588

(52) U.S. Cl. CPC H01M 50/262; H01M 50/211; H01M 50/284; H01M 50/517; H01M 50/588; H01M 10/0525; H01M 10/0565

(57) ABSTRACT

Battery protection circuit configurations are discussed which are detachable from the corresponding battery when the battery is scrapped or discarded. An apparatus includes a circuit substrate having interface elements configured to couple to tab terminals of a battery cell and output terminals configured to carry electrical current for the battery cell with respect to an external circuit. Each of the interface elements comprise an electrical contact that conductively contacts a mating tab terminal of the battery cell, and a releasable mechanism configured to hold the mating tab terminal against the electrical contact based at least on being placed in a locked state, and allow release the mating tab terminal based at least on being placed in an unlocked state.

### BACKGROUND

Rechargeable batteries, such as those that include lithium polymer (Li—Po) cells, a subset of lithium ion (Li-Ion) types of cells, typically have a high energy density as compared to prior technologies. Li—Po batteries are frequently employed in computing devices and portable electronic devices, as well as in various other high power density applications. Li—Po cells typically include use of a protection circuit module (PCM), which can be a part of a battery management system (BMS). Electrodes of the battery cells (e.g., anodes and cathodes) are often exposed from cell packaging via external wires or tabs and welded to a PCM. The PCM can provide a battery with overcharge protection, discharge protection, short circuit protection, or over-current limiting, and frequently provides voltage and current balancing among cells.

However, the packaging of these types of batteries can lead to increased electronic waste (e-waste) along with inefficient component selection and usage. Prismatic types of battery cells include rectangular packs that include a surrounding structural ‘can’ and often have long wire leads with a connector on the end of these long wires. Pouch types of battery cells have become more popular for use in electronic devices, such as in portable computers, smartphones, and tablet devices. Pouch cells typically have conductive tabs coupled to internal battery electrodes, and the tabs are then sealed in the pouch with the cells, leaving short portions of the tabs exposed. The exposed portions of the tabs are then directly welded to a corresponding circuit board of a PCM or other battery protection circuit module.

### SUMMARY

The examples herein describe enhanced mechanical interfaces for pouch type of batter cells which include tab style of terminals. The configurations discussed herein include several types of mechanical interfaces between a battery protection circuit and a corresponding battery cell which establish a detachable battery protection circuit, such as when a battery cell is scrapped or discarded. Specifically, the various types of enhanced mechanical interfaces discussed below establish different implementations for a removable interface for battery cell tabs with respect to a circuit board or a battery protection circuit.

In a first example, an apparatus includes a circuit substrate having interface elements configured to couple to tab terminals of a battery cell and output terminals configured to carry electrical current for the battery cell with respect to an external circuit. Each of the interface elements comprise an electrical contact that conductively contacts a mating tab terminal of the battery cell, and a releasable mechanism configured to hold the mating tab terminal against the electrical contact based at least on being placed in a locked state, and allow release the mating tab terminal based at least on being placed in an unlocked state.

In another example, an assembly includes a battery pack comprising a battery cell and tab terminals that provide electrode connections for the battery cell, and a battery protection module configured to provide at least charge level protection for the battery cell. The battery protection module comprises a circuit substrate having interface elements configured to couple to the tab terminals of the battery cell and output terminals configured to carry electrical current for the battery pack with respect to an external circuit. Each of the interface elements comprise an electrical contact that conductively contacts a mating tab terminal of the battery cell, and a releasable mechanism configured to hold the mating tab terminal against the electrical contact based at least on being placed in a locked state and allow release the mating tab terminal based at least on being placed in an unlocked state.

In yet another example, a method includes forming a battery pack comprising a pouch battery cell and a battery protection module configured to provide charge level protection for the pouch battery by at least coupling tab terminals of the pouch battery cell to the battery protection module with a releasable interface mechanism.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an example battery system in an implementation.

FIG. 2 illustrates an example clamp retained battery assembly in an implementation.

FIG. 3 illustrates an example connector retained battery assembly in an implementation.

FIG. 4 illustrates an example screw retained battery assembly in an implementation.

FIG. 5 illustrates an example spring retained battery assembly in an implementation.

FIG. 6 illustrates example tab body and adapter retaining features in an implementation.

### DETAILED DESCRIPTION

High energy density rechargeable batteries, such lithium polymer (Li—Po) types of cells, are commonly accompanied by battery protection circuitry that monitors for overcharge conditions and prevents a level of discharge which can damage the battery cells. However, various battery cell conditions can be monitored and prevented, such as over-voltage, under-voltage, and over-current, and the protection circuitry can provide a margin of safety for when an internal temperature of the battery cell or ambient conditions exceed operating ranges. One example circuit is the protection circuit module (PCM) which is frequently included as a sub-portion of a battery management system (BMS). PCMs typically have a tight physical coupling to the associated battery cells, and together might form a battery “pack” which then has positive/negative terminals available for external loads and charging circuitry. PCMs at a minimum include charge level protection, such as over-voltage protection (OVP), and comprise a controller or processor accompanied by one or more switching elements that can disconnect battery cells from each other and from external charging/discharging circuitry. BMS elements can integrate PCM functionality, and also provide battery cell charge balancing, various wear leveling or longevity monitoring and prevention, as well as provide various communication interfaces to provide status of the battery pack to external systems, such as charge levels, charge cycle statistics, failure reporting, and replacement indications, among other status and monitoring. Thus, the PCM typically provides a low-level and physically coupled safety circuit tailored to selected battery chemistries, while the BMS in general can provide abstracted high-level monitoring, status, and control over a battery system as a whole.

Among the Li-Ion and Li—Po chemistries, various physical packaging can be employed, such as cylindrical cells, prismatic cells, and pouch cells. Pouch types of battery cells have become more popular for use in low-profile and tightly integrated electronic devices, such as in portable computers, smartphones, and tablet devices. Pouch cells typically have electrolyte/anode/cathode cell arrangements sealed within a bag (i.e., ‘pouch’). To make external electrical contact with the anode/cathode of the cell structure, conductive tabs are welded (or soldered) to the anode/cathode, and the tabs are then sealed in the pouch along with the cells, leaving short portions of the tabs exposed. The exposed portions of the tabs are then directly welded to a corresponding circuit substrate of a PCM or other battery protection circuit module. The use of a weld or spot weld ensures that localized heating from the weld operation is not substantially transported to the battery cell, unlike some forms of soldering which would conduct unwanted heat to the cell electrodes or electrolytes. However, as mentioned above, this direct welding of pouch battery cells to a corresponding PCM can lead to difficulties in manufacturing, recycling, disposal, and re-use of the PCM circuit modules when a welded/soldered battery is at end-of-life.

The battery protection circuitry configurations discussed herein are detachable from the corresponding battery cells when the battery cell is scrapped or discarded. The battery protection circuitry includes an enhanced mechanical interface between the battery protection circuitry and the battery cells. The mechanical interface can take several forms to establish a removable interface for electrode tabs with respect to a circuit substrate of the battery protection circuitry. Although the circuit substrates discussed herein can comprise a circuit board, such as a printed circuit board, the circuit substrates might alternatively comprise a flexible printed circuit (FPC) or rigid-flex arrangement, among other types of circuit assemblies and printed circuit configurations.

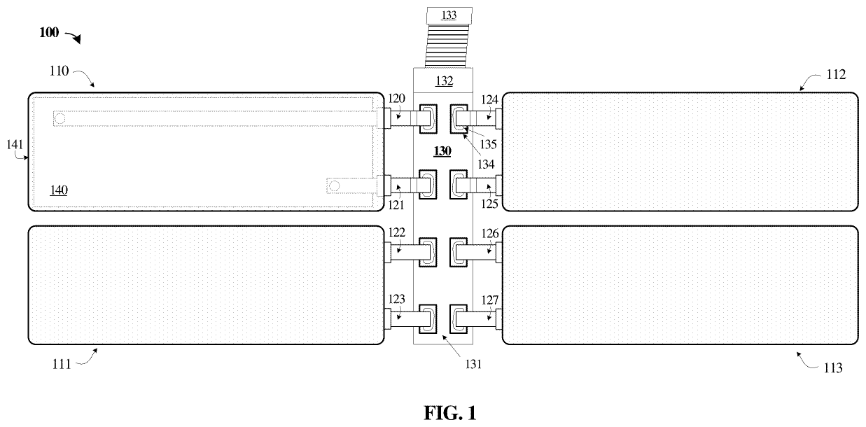

First, a battery system which includes pouch cells and welded tabs is included in FIG. 1. FIG. 1 includes battery system 100, which may be employed in a laptop or notebook computer, tablet computer, smartphone, portable electronic devices, or other battery-powered devices. System 100 includes batteries 110-113, which are coupled over corresponding battery tabs 120-127 to battery protection module 130. Battery protection module 130 includes circuit board 131 which houses battery protection circuitry 132 and external connection 133. External connection 133 can couple to various circuitry, such as charge/discharge circuitry or load circuitry over a corresponding set of electrical connections which can be provided over one or more terminals or connectors. In operation, typical electrical currents handled by battery system 100 can include several amps (A) to several dozen amps at peak outputs or peak charging.

Circuit board 131 comprises a printed circuit board assembly with a laminated or layered circuit board having traces or planes which contact and couple tabs from each battery cell 110-113, as well as isolate positive voltage connections from ground/reference connections. To couple with tabs of each battery cell, circuit board 131 includes conductive pads that receive battery tabs, with one example pad labeled for pad 134 which couples to tab 124. Example weld 135 is also included which couples pad 134 to tab 124. Weld 135 might comprise spot weld arrangements or instead may comprise solder or other flowable/re-flowable conductive materials. Similar features are found for the other tabs and pads in FIG. 1. Circuit board 131 can include other features, such as analog/digital circuitry, integrated circuits, discrete circuitry, circuitry footprints, vias, traces/routes, fastener holes/features, conformal coatings, silk screening, labels, connectors, and other various elements.

Battery cells 110-113 may comprise a pouch configuration or style of battery cells, although other types may instead be included. While the battery chemistry of battery cells 110-113 can also vary, in the examples herein a Li—Po battery chemistry is selected. As mentioned, pouch cells typically have electrolyte/anode/cathode cell arrangements sealed within a pouch container, along with separators, fillers, binders, adhesives, or other compounds. To make external electrical contact with the anode/cathode of the layered structure, conductive tabs are soldered/welded to the anode/cathode, and the tabs are then sealed in the pouch along with the cells, leaving short portions of the tabs exposed. Battery tabs 120-127, also referred to as tab terminals, are shown for battery cells 110-113. Battery tabs 120-127 are composed of flexible or bendable conductive materials (e.g., aluminum, copper, or nickel) that are directly welded/soldered to a corresponding circuit board of a PCM.

Battery cell 110 includes example detailed features, which batteries 111-113 may also include, although variations are possible. Battery cell 110 includes battery cell structure 140 which is sealed within a container, namely pouch 141. Battery cell structure 140 includes electrodes, electrolyte, and separator elements. Battery cell 110 also includes an internal portion of tab 120 which extends into pouch 141 and makes contact with a corresponding electrode. Similarly, an internal portion of tab 121 extends into pouch 141 and makes contact with a different corresponding electrode than tab 120. Tabs generally have a geometry which is “flat”, with a width and length substantially larger than the tab material thickness. Example tab thicknesses include approximately 80-100 micrometers (μm).

Battery protection circuitry 132 comprises circuitry at least configured to monitor for overcharge conditions and prevent a level of discharge which can damage battery cells 110-113. Battery protection circuitry 132 can include a controller or processor accompanied by one or more switching elements that can disconnect battery cells 110-113 from external connection 133 and from each other. However, various other battery cell conditions might be monitored and prevented by battery protection circuitry 132, such as over-voltage, under-voltage, and over-current, and to provide a margin of safety for when internal temperatures of batteries 110-113 (or ambient conditions) exceed operating ranges.

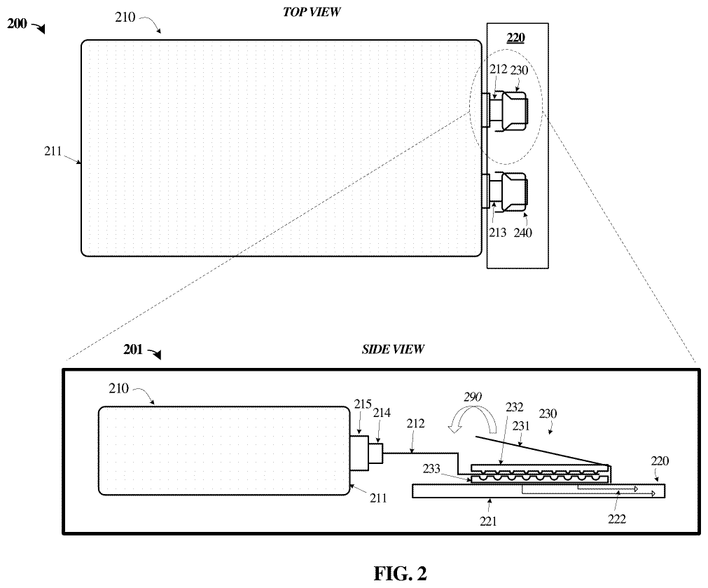

Although battery tabs 120-127 are shown as welded or soldered to corresponding pads in FIG. 1, elements of FIG. 1 can instead be fitted with the enhanced mechanical interfaces discussed below in FIGS. 2-7.

Turning next to FIG. 2, an example implementation of a clamp retained battery assembly is illustrated. View 200 is a top view of battery cell 210 coupled to protection circuit module (PCM) 220 at battery tabs 212-213 by interface elements 230 and 240. View 201 is a side view of battery cell 210 and illustrates a detailed view of interface element 230 which couples battery tab 212 of battery cell 210 to PCM 220.

Battery cell 210 includes pouch 211 which surrounds a battery cell structure and provides battery tabs 212-213 which contact internal electrode terminals of the battery cell (e.g., cathode and anode). Pouch 211 comprises a polymer or plastic material bonded to a metal or metal compound, such as aluminum-coated plastic films including mylar or various other materials. Battery cell 210 also can include various mechanical stress relief and sealing features to transition from pouch 211 to battery tabs 212-213. View 201 illustrates terrace 215 and tab root 214 which secure battery tab 212 to pouch 211 and ensure electrical and mechanical stability between internal electrode connections and battery tab 212. Various sealing features, such as adhesives, heat-shrink materials, plastic/metal welds, and the like, can be employed to form terrace 215 and tab root 214. Similar features can be provided for battery tab 213.

PCM 220 includes circuit board 221 and two interface elements 230 and 240, one for each battery tab 212-213, although a different quantity can instead be included. PCM 220 can also include various elements discussed herein for battery protection modules or protection circuit modules, such as a controller or processor accompanied by one or more switching elements. However, instead of welded or soldered battery tabs, PCM 220 includes releasable mechanisms for each battery tab. Specifically, each of interface elements 230 and 240 comprise an electrical contact that conductively contacts a mating tab terminal of battery cell 210, and a releasable mechanism configured to hold the mating tab terminal against the electrical contact based at least on being placed in a captive or locked state, and allow release the mating tab terminal based at least on being placed in a released state or unlocked state. In this example, the releasable mechanism comprises a lever activated latching mechanism configured to compress a battery tab against an electrical contact based on being placed in a captive or locked state.

In view 201, interface element 230 includes latching mechanism 231, upper contact plate 232, and lower contact plate 233. Latching mechanism 231 includes a lever or movable member which opens and closes upper contact plate 232 with respect to lower contact plate 233. Operation 290 highlights an example lever movement. When closed, upper contact plate 232 and lower contact plate 233 can compressively hold battery tab 212 between optional textured jaws or contact surfaces. When opened, upper contact plate 232 and lower contact plate 233 can spread apart to allow for release of battery tab 212. Also, latching mechanism 231 is configured to ‘lock’ or remain in the closed state to ensure that battery tab 212 is held within interface element between upper contact plate 232 and lower contact plate 233. The locking feature can include a further latch or lip under which the lever of latching mechanism 231 is retained. In this manner, battery tab 212 is held mechanically in contact with upper contact plate 232 and lower contact plate 233, which can then provide electrical or conductive contact between battery tab 212 and further electrical connections. Example electrical connections 222 are shown embedded within (or on a surface of) circuit board 221 forming PCM 220. These electrical connections can be routed to PCM circuitry for monitoring/control and to external circuitry (e.g., charge/discharge or load circuitry).

Although FIG. 2 shows a latch with a lever-locking mechanism, other mechanisms can be employed instead of a lever-activated mechanism. Examples include push-button locking mechanisms, spring-activated locking mechanisms, cam or rotating locking mechanisms, magnetic locking mechanisms, conductive adhesives, epoxies, conductive pastes, among others. Various other fasteners or fastening elements can be included, such as adhesive or screws. If one-way/one-time attachment is desired, such as for security or tamper-resistance, then a breakaway feature can be incorporated into interface elements 230 and 240 to allow battery cell 210 to be removed/separated by breaking a portion of interface elements 230 and 240. This portion can then be replaced or reset when a new battery tab coupling is desired. If conductive adhesives or pastes are employed, then the adhesive/paste can be applied to hold battery tabs to a conductive footprint of a circuit substrate of the PCM, or to supplement the fastening properties of a releasable mechanism. A curing process can be employed to harden or complete an adhesion process. A removal process can include dissolving the adhesive or paste using a suitable solvent, or physical separation which exceeds a bonding force of the adhesive/paste, cracking the adhesive/paste, or other mechanical/physical removal process.

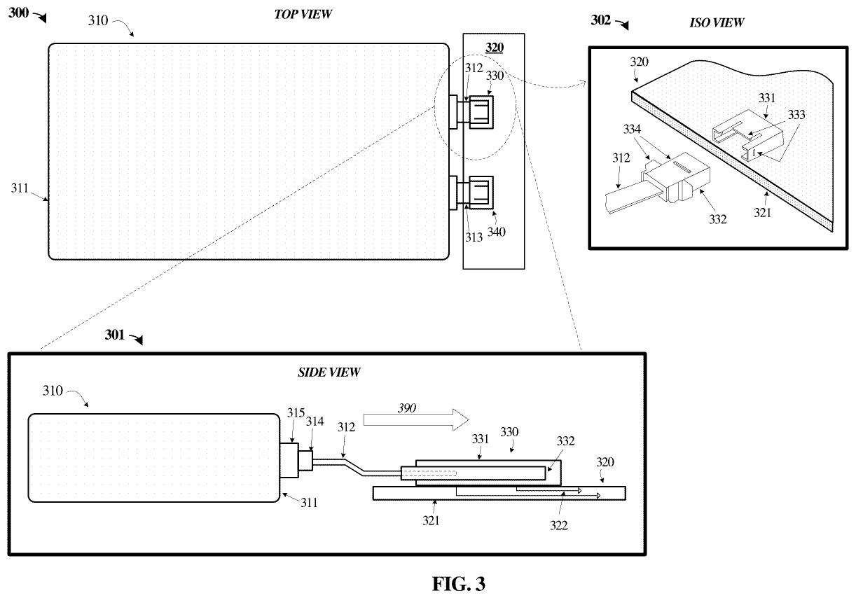

Turning now to FIG. 3, an example implementation of a connector retained battery assembly is illustrated. View 300 is a top view of battery cell 310 coupled to PCM 320 at battery tabs 312-313 by connectors 330 and 340. View 301 is a side view of battery cell 310 and illustrates a detailed view of connector 330 which couples battery tab 312 of battery 310 to PCM 320.

Battery cell 310 includes pouch 311 which surrounds a battery cell structure and provides battery tabs 312-313 which contact internal electrode terminals of the battery cell (e.g., cathode and anode). Battery cell 310 also can include various mechanical stress relief and sealing features to transition from pouch 311 to battery tabs 312-313. View 301 illustrates terrace 315 and tab root 314 which secure battery tab 312 to pouch 311 and ensure electrical and mechanical stability between internal electrode connections and battery tab 312. Various sealing features, such as adhesives, heat-shrink materials, plastic/metal welds, and the like, can be employed to form terrace 315 and tab root 314. Similar features can be provided for battery tab 313.

PCM 320 includes circuit board 321 and two interface elements comprising connectors 330 and 340, one for each battery tab 312-313, although a different quantity can instead be included. PCM 320 can also include various elements discussed herein for battery protection modules or protection circuit modules, such as a controller or processor accompanied by one or more switching elements. However, instead of welded or soldered battery tabs, PCM 320 includes releasable connector mechanisms for each battery tab. Specifically, each of connectors 330 and 340 comprise an electrical contact that conductively contacts a mating tab terminal of battery cell 310, and a releasable connector mechanism configured to hold the mating tab terminal against the electrical contact based at least on being placed in a locked state, and allow release the mating tab terminal based at least on being placed in an unlocked state. Connectors 330 and 340 include electrical contacts, such as terminals which are soldered onto a footprint or pads of circuit board 321 and couple electrically to traces/planes which carry accompanying electrical current of the battery tab. View 301 shows example electrical connections 322 embedded within (or on a surface of) circuit board 321 forming PCM 320. These electrical connections can be routed to PCM circuitry for monitoring/control and to external circuitry (e.g., charge/discharge or load circuitry). Connectors 330 and 340 might be sized according to the application, such as to support a current-carrying capability of a selected battery cell, such as 2.6 millimeters (mm) for an example height of connector body 331.

Also, in view 301, connector 330 includes connector body 331 having retention features that mate with mating connector 332 comprising battery tab 312. Based on insertion of mating connector 332 housing battery tab 312 into connector body 331, the retention features retain mating connector 332 in contact with an electrical contact and place connector 330 in the locked state. Based on a removal force exceeding a threshold force on mating connector 332, connector body 331 allows release of mating connector 332 and produce the unlocked state. View 302 shows further details of connector 330 which includes connector body 331 mounted to circuit board 321 of PCM 320. Also shown in view 302 is mating connector 332 which is coupled to battery tab 312, such as by crimping, solder, screws, friction fitment, or other coupling technique. Connector body 331 can include various retention features 333, such as tabs, receiving slots, or other features. Connector body 331 might comprise a socket or receptacle assembly. During mating operation 390, connector body 331 receives mating connector 332 which has retention features 334 that interlock with retention features 333. An insertion force and release force can be established by the material properties, geometry, and other fitment considerations. Responsive to the insertion force being reached, connector body 331 engages and locks with mating connector 332, preventing release of connector body 331 from mating connector 332 until a release force is exceeded and retention features are disengaged.

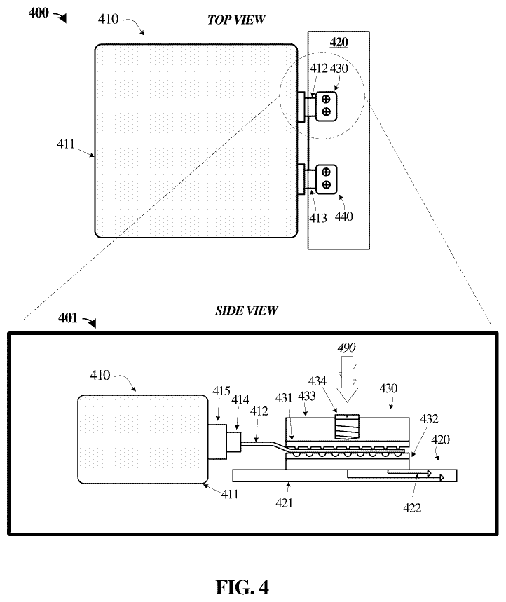

Turning next to FIG. 4, an example implementation of a screw retained battery assembly is illustrated. View 400 is a top view of battery cell 410 coupled to PCM 420 at battery tabs 412-413 by interface elements 430 and 440. View 401 is a side view of battery cell 410 and illustrates a detailed view of interface element 430 which couples battery tab 412 of battery cell 410 to PCM 420.

Battery cell 410 includes pouch 411 which surrounds a battery cell structure and provides battery tabs 412-413 which contact internal electrode terminals of the battery cell (e.g., cathode and anode). Battery cell 410 also can include various mechanical stress relief and sealing features to transition from pouch 411 to battery tabs 412-413. View 401 illustrates terrace 415 and tab root 414 which secure battery tab 412 to pouch 411 and ensure electrical and mechanical stability between internal electrode connections and battery tab 412. Similar features can be provided for battery tab 413.

PCM 420 includes circuit board 421 and two interface elements 430 and 440, one for each battery tab 412-413, although a different quantity can instead be included. PCM 420 can also include various elements discussed herein for battery protection modules or protection circuit modules, such as a controller or processor accompanied by one or more switching elements. However, instead of welded or soldered battery tabs, PCM 420 includes releasable mechanisms for each battery tab. Specifically, each of interface elements 430 and 440 comprise an electrical contact that conductively contacts a mating tab terminal of battery cell 410, and a releasable mechanism configured to hold the mating tab terminal against the electrical contact based at least on being placed in a captive or locked state, and allow release the mating tab terminal based at least on being placed in a released state or unlocked state. In this example, the releasable mechanism comprises a screw activated latching mechanism configured to compress a battery tab against an electrical contact based on being placed in a captive or locked state.

In view 401, interface element 430 includes upper contact plate 431, lower contact plate 432, and screw mechanism 433 that houses screw 434. To mate battery tab 412 with interface element 430, battery tab 412 is slid or placed between upper contact plate 431 and lower contact plate 432. Then, screw mechanism 433 is activated which compresses upper contact plate 431 and lower contact plate 432, engaging battery tab 412. When closed, upper contact plate 431 and lower contact plate 432 can compressively hold battery tab 412 between optional textured jaws or contact surfaces. When opened, upper contact plate 431 and lower contact plate 432 can spread apart to allow for release of battery tab 412. In this manner, battery tab 412 is held mechanically in contact with upper contact plate 431 and lower contact plate 432, which can then provide electrical or conductive contact between battery tab 412 and further electrical connections. Example electrical connections 422 are shown embedded within (or on a surface of) circuit board 421 forming PCM 420. These electrical connections can be routed to PCM circuitry for monitoring/control and to external circuitry (e.g., charge/discharge or load circuitry).

Screw mechanism 433 is shown as including one or more threaded members (e.g., screw 434) which are rotated to place a force onto upper contact plate 431. Screw mechanism 433 or screw 434 might have captive features to prevent loss of screw 434 from screw mechanism 433. Other types of retention mechanisms or features can instead be employed, such as push-button locking mechanisms, spring-activated locking mechanisms, cam or rotating locking mechanisms, magnetic locking mechanisms, conductive adhesives, epoxies, conductive pastes, among others. Various other fasteners or fastening elements can be included, such as adhesives. If one-way/one-time attachment is desired, such as for security or tamper-resistance, then a breakaway feature can be incorporated into interface elements 430 and 440 to allow battery cell 410 to be removed/separated by breaking a portion of interface elements 430 and 440. This portion can then be replaced or reset when a new battery tab coupling is desired.

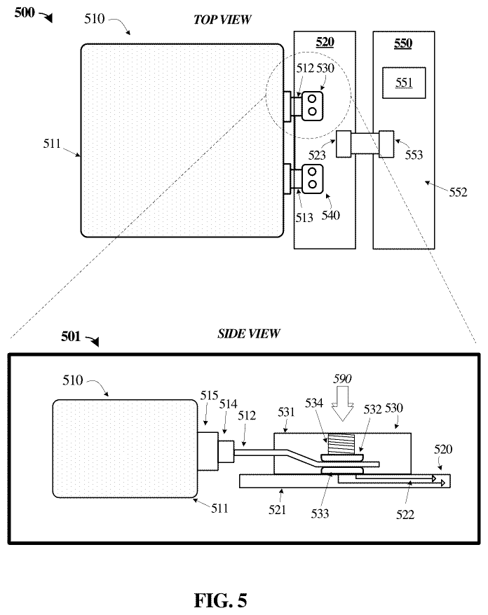

FIG. 5 illustrates another example similar to that found in FIG. 4, but includes a spring retained battery assembly instead of a screw mechanism. View 500 is a top view of battery cell 510 coupled to circuit assembly 520 at battery tabs 512-513 by interface elements 530 and 540. Circuit assembly 520 is further coupled to PCM 550 by connector assembly 523 and connector assembly 553. View 501 is a side view of battery cell 510 and illustrates a detailed view of interface element 530 which couples battery tab 512 of battery cell 510 to circuit assembly 520.

Battery cell 510 includes pouch 511 which surrounds a battery cell structure and provides battery tabs 512-513 which contact internal electrode terminals of the battery cell (e.g., cathode and anode). Battery cell 510 also can include various mechanical stress relief and sealing features to transition from pouch 511 to battery tabs 512-513. View 501 illustrates terrace 515 and tab root 514 which secure battery tab 512 to pouch 511 and ensure electrical and mechanical stability between internal electrode connections and battery tab 512. Similar features can be provided for battery tab 513.

Circuit assembly 520 includes circuit substrate 521 and two interface elements 530 and 540, one for each battery tab 512-513, although a different quantity can instead be included. However, instead of welded or soldered battery tabs, circuit assembly 520 includes releasable mechanisms for each battery tab. Specifically, each of interface elements 530 and 540 comprise an electrical contact that conductively contacts a mating tab terminal of battery cell 510, and a releasable mechanism configured to hold the mating tab terminal against the electrical contact based at least on being placed in a captive or locked state, and allow release the mating tab terminal based at least on being placed in a released state or unlocked state. In this example, the releasable mechanism comprises a spring activated latching mechanism configured to compress a battery tab against an electrical contact based on being placed in a captive or locked state. Circuit substrate 521 can comprise a circuit board, such as described herein for various printed circuit boards, or could alternatively comprise a flexible printed circuit (FPC) or rigid-flex arrangement, among other types of circuit assemblies and printed circuit configurations.

In view 501, interface element 530 includes body 531, upper contact plate 532, lower contact plate 533, and spring mechanism 534. To mate battery tab 512 with interface element 530, battery tab 512 is slid or placed between upper contact plate 532 and lower contact plate 533. Then, spring mechanism 534 is activated which compresses upper contact plate 532 and lower contact plate 533, engaging battery tab 512. Upper contact plate 532 and lower contact plate 533 can compressively hold battery tab 512 between optional textured jaws or contact surfaces. Upper contact plate 532 and lower contact plate 533 can spread apart to allow for release of battery tab 512. In this manner, battery tab 512 is held mechanically in contact with upper contact plate 532 and lower contact plate 533, which can then provide electrical or conductive contact between battery tab 512 and further electrical connections. Example electrical connections 522 are shown embedded within (or on a surface of) circuit substrate 521 forming circuit assembly 520. These electrical connections can be routed to connector assembly 523 for coupling to PCM 550.

Spring mechanism 534 is shown as including one or more tension members (e.g., springs) which place a force onto upper contact plate 532. Spring mechanism 434 can engage with battery tab 512 with the aid of mating features formed into battery tab 512, such as to engage a protrusion on upper contact plate 532 or lower contact plate 533 with a cavity, hole, or notch on battery tab 512. Thus, spring mechanism 534 and interface element 530 includes a releasable mechanism comprising a spring configured to compressively engage an electrical contact (upper contact plate 532 or lower contact plate 533) with mating features of battery tab 512 based on insertion of battery tab 512. Spring mechanism 534 retains battery tab 512 and places a spring and contact features in a locked state with battery tab 512. Spring mechanism 534 comprises a mating feature configured to mate with battery tab 512 responsive to insertion of battery tab 512 into body 331 and prevent removal of battery tab 512 until spring mechanism 534 is released in the unlocked state. The insertion, locking, and removal can be established by various spring-mediated insertion force thresholds and release force thresholds, such as those discussed above for connectors 330 and 340.

FIG. 5 shows an alternative implementation having a two-circuit board configuration where circuit assembly 520 includes connections to battery cell 510 and battery tabs 512-513. Circuit assembly 520 is then further coupled over connector assembly 523 to PCM 550. PCM 550 comprises circuit board 552 and connector assembly 553, but other connector or connection configurations are possible between circuit assembly 520 and PCM 550, such as cables, connectors, sockets/plugs, magnetic connection assemblies, flexible circuit board connections, soldered connections, discrete wires, and other connection types. In this example, PCM 550 instead of circuit assembly 520 includes various elements discussed herein for battery protection modules or protection circuit modules, such as a controller or processor accompanied by one or more switching elements. PCM 550 then includes further electrical connections that are routed from connector assembly 553 to PCM circuitry for monitoring/control and to external circuitry (e.g., charge/discharge or load circuitry). In some examples, PCM 550 might also be included on a motherboard or system board of a computing device.

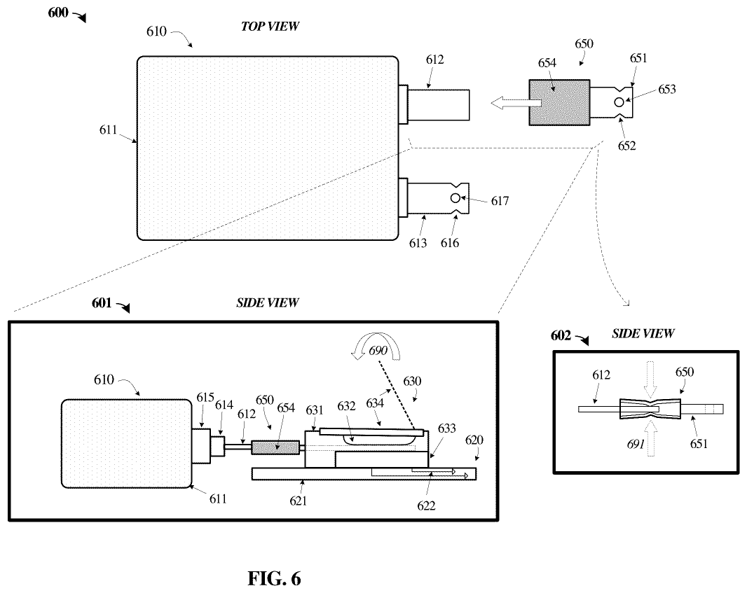

FIG. 6 illustrates another example similar to that found in FIG. 2, but includes mating features formed in a body of a battery tab or formed into an add-on element or tab extension that is coupled to a battery tab. These mating features or tab extensions can then mate with retention features of enhanced interface elements. View 600 is a top view of battery cell 610 which is configured to couple to PCM 620 at battery tabs 612-613. View 601 is a side view of battery cell 610 and illustrates a detailed view of battery cell 610 coupled to PCM 620 by interface element 630 with tab extension 650 mounted to battery tab 612. Thus, FIG. 6 shows two example interfacing configurations, a first configuration shown for battery tab 613 having mating features formed in a body of battery tab 613, and a second configuration shown for battery tab 612 having mating features formed into tab extension 650 mounted to battery tab 612. Typically, one of the configurations will be selected for use in a battery system, although variations are possible.

Battery cell 610 includes pouch 611 which surrounds a battery cell structure and provides battery tabs 612-613 which contact internal electrode terminals of the battery cell (e.g., cathode and anode). Battery cell 610 also can include various mechanical stress relief and sealing features to transition from pouch 611 to battery tabs 612-613. View 601 illustrates terrace 615 and tab root 614 which secure battery tab 612 to pouch 611 and ensure electrical and mechanical stability between internal electrode connections and battery tab 612. Similar features can be provided for battery tab 613.

PCM 620 includes circuit board 621 and two interface elements, one for each battery tab 612-613, although a different quantity can instead be included. PCM 620 can also include various elements discussed herein for battery protection modules or protection circuit modules, such as a controller or processor accompanied by one or more switching elements. However, instead of welded or soldered battery tabs, PCM 620 includes releasable mechanisms for each battery tab. Specifically, each of the interface elements (example interface element 630 is visible in view 601) comprise an electrical contact that conductively contacts a mating tab terminal of battery cell 610, and a releasable mechanism configured to hold the mating tab terminal against the electrical contact based at least on being placed in a captive or locked state, and allow release the mating tab terminal based at least on being placed in a released state or unlocked state. In this example, the releasable mechanism comprises a lever activated latching mechanism configured to compress a battery tab against an electrical contact based on being placed in a captive or locked state.

View 600 shows battery tab 613 having various mating features formed in a body of battery tab 613. These mating features can vary, but in this example include notches 616 and hole 617. Notches 616 and/or hole 617 can be configured to engage with retention features of a mating connector assembly mounted to PCM 620. The retention features can be activated responsive to insertion of battery tab 613 into a connector assembly port or socket which prevents removal of the battery tab until the latching mechanism is released into an unlocked state. A locked state can be achieved by establishing a threshold insertion force to engage retention features, and the unlocked state can be achieved using a threshold removal force to disengage the retention features. Alternatively, various lever activated, spring activated, screw retained, magnetic activated/retained, or other configurations can be included, such as those discussed above.

For instance, view 601 shows one example lever activated locking and retention mechanism for battery tabs having mating features or for battery tabs having a tab extension. Specifically, battery tab 612 can include tab extension 650 mounted to battery tab 612. Tab extension 650 is shown in view 600 has having mating features, such as notches 652 and hole 653. In this manner, battery tab 612 can remain unmodified, while tab extension 650 includes mating features. To couple battery tab 612 to tab extension 650, various techniques can be employed. A crimped connector configuration is shown in view 602. View 602 shows crimping operation 691 which crimps sleeve 654 onto tab 612 and thus couple extension tab 651 of tab extension 650 onto battery tab 612. Notches 652 and/or hole 653 can be configured to engage with retention features of mating interface element 630 mounted to PCM 620. The retention features can be activated responsive to insertion of extension tab 651 into connector assembly 630.

Specifically, interface element 630 comprises an electrical contact that conductively contacts extension tab 651 of tab extension 650, and a releasable mechanism configured to hold extension tab 651 against the electrical contact based at least on being placed in a captive or locked state, and allow release extension tab 651 based at least on being placed in a released state or unlocked state. In this example, the releasable mechanism comprises a lever activated latching mechanism configured to compress extension tab 651 against an electrical contact based on being placed in a captive or locked state.

In view 601, interface element 630 includes body 631, upper contact plate 232, lower contact plate 633, and latching mechanism 634. Latching mechanism 234 includes a lever or movable member which opens and closes upper contact plate 632 with respect to lower contact plate 633. Operation 690 highlights an example lever movement. When closed, upper contact plate 632 and lower contact plate 633 can compressively hold extension tab 651 between retention elements or surfaces that mate with associated mating features (e.g., notches or holes of extension tab 651). When opened, upper contact plate 632 and lower contact plate 633 can spread apart to allow for release of extension tab 651. Also, latching mechanism 634 is configured to ‘lock’ or remain in the closed state to ensure that extension tab 651 is held within interface element between upper contact plate 632 and lower contact plate 633. The locking feature can include a further latch or lip under which the lever of latching mechanism 634 is retained. In this manner, extension tab 651 is held mechanically in contact with upper contact plate 632 and lower contact plate 633, which can then provide electrical or conductive contact between extension tab 651 and further electrical connections. Example electrical connections 622 are shown embedded within (or on a surface of) circuit board 621 forming PCM 620. These electrical connections can be routed to PCM circuitry for monitoring/control and to external circuitry (e.g., charge/discharge or load circuitry).

Thus, the examples herein discuss various enhanced mechanical interfaces for coupling battery tabs to battery protection circuit modules or PCMs. In one example, a method of manufacturing or assembly includes forming an assembly, referred to as a battery pack, comprising a pouch battery cell and a battery protection module configured to provide charge level protection for the pouch battery cell by at least coupling tab terminals of the pouch battery cell to the battery protection module with a releasable interface mechanism. The releasable mechanism can be disengaged to decouple the battery cell from the battery protection module, such as to discard the battery cell and reuse the battery protection module following end-of-life of the battery cell. In some examples, battery protection modules carry a considerable cost with respect to the battery assembly, such as approximately 30% of the total material cost in the bill-of-materials. The only item that carries a more significant cost is typically the battery cell (e.g., pouch). In conventional systems, when a battery cell is scrapped, the battery protection module must also be scrapped due to the battery cell tabs being welded to the battery protection module, even though the battery protection module itself may still be usable. The examples herein provide enhanced mechanical interfaces to allow disengagement of the battery cell from the battery protection module and can help alleviate this unnecessary waste. The battery protection module also makes up a large portion of the carbon footprint of the battery assembly, almost as much as the battery cell itself. Enabling re-use of battery protection modules might help reduce the carbon footprint of many types of computing devices. In addition, supply chain pressures from critical integrated circuits could be reduced when battery protection modules are configured to be reusable as discussed herein. The attachable/de-attachable interconnect methods, techniques, assemblies, and configurations discussed herein have several advantages including enabling re-use of battery protection modules by avoiding the welded connections that cannot be detached without impractical and intensive processes, such as de-soldering welded tabs or re-soldering new tabs. This enhanced configuration can lead to helping achieve carbon footprint reduction goals, decreased costs of battery packs over their lifecycle, decreased costs of repaired devices, and reduced impact of supply chain bottlenecks of critical integrated circuits and materials used to make battery protection modules.

Certain inventive aspects may be appreciated from the foregoing disclosure, of which the following are various examples.

Example 1: An apparatus, comprising a circuit board having interface elements configured to couple to tab terminals of a battery cell. Each of the interface elements comprises an electrical contact that conductively contacts a mating tab terminal of the battery cell, and a releasable mechanism configured to hold the mating tab terminal against the electrical contact based at least on being placed in a locked state, and allow release the mating tab terminal based at least on being placed in an unlocked state.

Example 2: The apparatus of Example 1, comprising a battery pouch housing the battery cell comprising a lithium-polymer (Li—Po) cell and the mating tab terminals that provide electrode connections for the battery cell.

Example 3: The apparatus of Examples 1-2, wherein the releasable mechanism comprises a lever activated latching mechanism configured to compress the mating tab terminal against the electrical contact based on being placed in the locked state.

Example 4: The apparatus of Examples 1-3, wherein the mating tab terminal comprises a mating feature formed in a body of the mating tab terminal configured to mate with a retention feature responsive to activation of the latching mechanism and prevent removal of the mating tab terminal until the latching mechanism is released in the unlocked state.

Example 5: The apparatus of Examples 1-4, wherein the releasable mechanism comprises a screw configured to compress the mating tab terminal against the electrical contact based on being in the locked state.

Example 6: The apparatus of Examples 1-5, wherein the mating tab terminal comprises a mating feature formed in a body of the mating tab terminal configured to accept the screw.

Example 7: The apparatus of Examples 1-6, wherein the releasable mechanism comprises a spring configured to compressively engage the electrical contact with mating features of the mating terminal tab based on insertion of the mating tab terminal into a corresponding interface element that retains the mating terminal tab and places the interface elements interface element in the locked state.

Example 8: The apparatus of Examples 1-7, wherein the mating features of the mating terminal tab comprise at least one among a hole in a body of the mating tab terminal or notches along the body of the mating tab terminal.

Example 9: The apparatus of Examples 1-8, wherein each of the interface elements further comprise a connector body having retention features that mate with a mating connector comprising the mating tab terminal, and wherein based on insertion of the mating tab terminal into the connector body, the retention features retain the mating connector in contact with the electrical contact and place the connector in the locked state.

Example 10: The apparatus of Examples 1-9, wherein based on a removal force exceeding a threshold force on the mating connector, the connector body allows release of the mating connector and produce the unlocked state.

Example 11: An assembly, comprising a battery pack comprising a battery cell and tab terminals that provide electrode connections for the battery cell, and a battery protection module configured to provide at least charge level protection for the battery cell. The battery protection module comprises a circuit board having interface elements configured to couple to the tab terminals of the battery cell and output terminals configured to carry electrical current for the battery pack with respect to an external circuit. Each of the interface elements comprising an electrical contact that conductively contacts a mating tab terminal of the battery cell, and a releasable mechanism configured to hold the mating tab terminal against the electrical contact based at least on being placed in a locked state, and allow release the mating tab terminal based at least on being placed in an unlocked state.

Example 12: The assembly of Example 11, wherein the battery cell comprises a battery pouch housing the battery cell and the tab terminals that provide electrode connections for the battery cell.

Example 13: The assembly of Examples 11-12, wherein the releasable mechanism comprises a lever activated latching mechanism configured to compress the mating tab terminal against the electrical contact based on being placed in the locked state.

Example 14: The assembly of Examples 11-13, wherein the mating tab terminal comprises a mating feature formed in a body of the mating tab terminal configured to mate with a retention feature responsive to activation of the latching mechanism and prevent removal of the mating tab terminal until the latching mechanism is released in the unlocked state.

Example 15: The assembly of Examples 11-14, wherein the releasable mechanism comprises a screw configured to compress the mating tab terminal against the electrical contact based on being in the locked state.

Example 16: The assembly of Examples 11-15, wherein the mating tab terminal comprises a mating feature formed in a body of the mating tab terminal configured to accept the screw.

Example 17: The assembly of Examples 11-16, wherein the releasable mechanism comprises a spring configured to compressively engage the electrical contact with mating features of the mating terminal tab based on insertion of the mating tab terminal into a corresponding interface element that retains the mating terminal tab and places the corresponding interface element in the locked state.

Example 18: The assembly of Examples 11-17, wherein the mating features of the mating terminal tab comprise at least one among a hole in a body of the mating tab terminal or notches along the body of the mating tab terminal.

Example 19: The assembly of Examples 11-18, wherein each of the interface elements further comprise a connector body having retention features that mate with a mating connector comprising the mating tab terminal. Based on insertion of the mating tab terminal into the connector body, the retention features retain the mating connector in contact with the electrical contact establish the locked state. Based on a removal force exceeding a threshold force on the mating connector, the connector body configured to allow release of the mating connector and produce the unlocked state.

Example 20: A method, comprising forming a battery pack comprising a pouch battery cell and a battery protection module configured to provide charge level protection for the pouch battery cell by at least coupling tab terminals of the pouch battery cell to the battery protection module with a releasable interface mechanism.

Battery cells discussed herein comprise pouch style of battery cells having tab terminals connecting to the internal electrodes of the battery cell. However, the examples, scenarios, techniques, mechanisms, operations, and assemblies herein are not limited to pouch style of cells. Other types of cells, including prismatic, cylindrical, or irregular can be employed. Moreover, although the tabs discussed herein are generally ‘flat’ terminals coupling to battery cell electrodes, other geometries, shapes, and tab configurations are possible. Also, the particular materials and chemistry of the battery cell, including the electrodes, separators, electrolyte, fillers, adhesives, pouch materials, and tab materials can vary beyond those employed in lithium polymer (Li—Po) and lithium ion (Li-Ion) types of cells.

The functional diagrams, operational scenarios and sequences, and other diagrams provided in the Figures are representative of exemplary systems, environments, and methodologies for performing novel aspects of the disclosure. The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The various materials and manufacturing processes discussed herein are employed according to the descriptions above. However, it should be understood that the disclosures and enhancements herein are not limited to these materials and manufacturing processes, and can be applicable across a range of suitable materials and manufacturing processes. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

What is claimed is:

1. An apparatus, comprising:
a circuit substrate having interface elements configured to couple to tab terminals of a battery cell; and
each of the interface elements comprising an electrical contact that conductively contacts a mating tab terminal of the battery cell, and a releasable mechanism configured to hold the mating tab terminal against the electrical contact based at least on being placed in a locked state, and allow release the mating tab terminal based at least on being placed in an unlocked state.

2. The apparatus of claim 1, comprising:
a battery pouch housing the battery cell comprising a lithium-polymer (Li—Po) cell and the mating tab terminals that provide electrode connections for the battery cell.

3. The apparatus of claim 1, wherein the releasable mechanism comprises a lever activated latching mechanism configured to compress the mating tab terminal against the electrical contact based on being placed in the locked state.

4. The apparatus of claim 3, wherein the mating tab terminal comprises a mating feature formed in a body of the mating tab terminal configured to mate with a retention feature responsive to activation of the latching mechanism and prevent removal of the mating tab terminal until the latching mechanism is released in the unlocked state.

5. The apparatus of claim 1, wherein the releasable mechanism comprises a screw configured to compress the mating tab terminal against the electrical contact based on being in the locked state.

6. The apparatus of claim 5, wherein the mating tab terminal comprises a mating feature formed in a body of the mating tab terminal configured to accept the screw.

7. The apparatus of claim 1, wherein the releasable mechanism comprises a spring configured to compressively engage the electrical contact with mating features of the mating terminal tab based on insertion of the mating tab terminal into a corresponding interface element that retains the mating terminal tab and places the interface elements interface element in the locked state.

8. The apparatus of claim 7, wherein the mating features of the mating terminal tab comprise at least one among a hole in a body of the mating tab terminal or notches along the body of the mating tab terminal.

9. The apparatus of claim 1, wherein each of the interface elements further comprise a connector body having retention features that mate with a mating connector comprising the mating tab terminal; and
wherein based on insertion of the mating tab terminal into the connector body, the retention features retain the mating connector in contact with the electrical contact and place the connector in the locked state.

10. The apparatus of claim 9, wherein based on a removal force exceeding a threshold force on the mating connector, the connector body allows release of the mating connector and produce the unlocked state.

11. An assembly, comprising:
a battery pack comprising a battery cell and tab terminals that provide electrode connections for the battery cell;
a battery protection module configured to provide at least charge level protection for the battery cell, the battery protection module comprising a circuit substrate having interface elements configured to couple to the tab terminals of the battery cell and output terminals configured to carry electrical current for the battery pack with respect to an external circuit; and
each of the interface elements comprising an electrical contact that conductively contacts a mating tab terminal of the battery cell, and a releasable mechanism configured to hold the mating tab terminal against the electrical contact based at least on being placed in a locked state, and allow release the mating tab terminal based at least on being placed in an unlocked state.

12. The assembly of claim 11, wherein the battery cell comprises a battery pouch housing the battery cell and the tab terminals that provide electrode connections for the battery cell.

13. The assembly of claim 11, wherein the releasable mechanism comprises a lever activated latching mechanism configured to compress the mating tab terminal against the electrical contact based on being placed in the locked state.

14. The assembly of claim 13, wherein the mating tab terminal comprises a mating feature formed in a body of the mating tab terminal configured to mate with a retention feature responsive to activation of the latching mechanism and prevent removal of the mating tab terminal until the latching mechanism is released in the unlocked state.

15. The assembly of claim 11, wherein the releasable mechanism comprises a screw configured to compress the mating tab terminal against the electrical contact based on being in the locked state.

16. The assembly of claim 15, wherein the mating tab terminal comprises a mating feature formed in a body of the mating tab terminal configured to accept the screw.

17. The assembly of claim 11, wherein the releasable mechanism comprises a spring configured to compressively engage the electrical contact with mating features of the mating terminal tab based on insertion of the mating tab terminal into a corresponding interface element that retains the mating terminal tab and places the corresponding interface element in the locked state.

18. The assembly of claim 17, wherein the mating features of the mating terminal tab comprise at least one among a hole in a body of the mating tab terminal or notches along the body of the mating tab terminal.

19. The assembly of claim 11, wherein each of the interface elements further comprise:
a connector body having retention features that mate with a mating connector comprising the mating tab terminal;
based on insertion of the mating tab terminal into the connector body, the retention features retain the mating connector in contact with the electrical contact establish the locked state; and
based on a removal force exceeding a threshold force on the mating connector, the connector body configured to allow release of the mating connector and produce the unlocked state.

20. A method, comprising:
forming a battery pack comprising a pouch battery cell and a battery protection module configured to provide charge level protection for the pouch battery cell by at least coupling tab terminals of the pouch battery cell to the battery protection module with a releasable interface mechanism.
